(19) United States
(12) Patent Application Publication
(10) Pub. No.: US 2012/0138593 A1
(43) Pub. Date: Jun. 7, 2012

(54) OPEN WARMING CABINET

(76) Inventors: Jeff G. Franklin, Zion, IL (US); Jeffrey S. Erber, Edwardsville, IL (US); Paul M. Emerich, Laguna Beach, CA (US)

(21) Appl. No.: 13/272,726

(22) Filed: Oct. 13, 2011

Related U.S. Application Data
(60) Provisional application No. 61/393,124, filed on Oct. 14, 2010.

(51) Int. Cl. A47J 36/24

(52) U.S. Cl. 219/400; 220/592.28

(57) ABSTRACT

A heated food storage container is provided. The container includes a housing with upper and lower walls, right and left walls, and a rear wall. The housing defines an internal volume accessible through an open front portion. A ventilation duct includes an upper chamber, a rear chamber in fluid communication with the upper chamber, and a lower chamber in fluid communication with the rear chamber. The lower chamber is defined between an internal lower wall and the lower wall. A plurality of parallel beams support the internal lower wall, and define a plurality of separated air flow paths through the lower chamber. Each of the plurality of parallel beams are shaped as truncated triangular members with a truncated end disposed proximate an exit of the lower chamber.

### CROSS-REFERENCE TO RELATED APPLICATIONS

This application claims priority from U.S. Provisional Application No. 61/393,124, filed on Oct. 14, 2010, the entirety thereof is hereby full incorporated by reference herein.

### TECHNICAL FIELD

This disclosure relates to the field of containers and cabinets that are configured to hold and maintain pre-cooked food product items warm and moist for later use by a kitchen or restaurant facility.

### BRIEF SUMMARY

A first representative embodiment of the disclosure is provided. The first representative embodiment is a heated food storage container. The container includes a housing with upper and lower walls, right and left walls, a rear wall and defining an internal volume accessible through an open front portion. A heater and a fan are disposed within the housing and configured to deliver a flow of heated air through a ventilation duct defined within the housing. The ventilation duct includes an upper chamber, a rear chamber in fluid communication with the upper chamber, and a lower chamber in fluid communication with the rear chamber. A cowling is disposed upon a front portion of the lower chamber and configured to direct air flowing through the lower chamber in parallel with the lower wall to a second direction through the open front portion and toward an intake of the upper chamber. The cowling is configured to initially urge the air leaving the cowling at a first acute angle with respect to the lower chamber

A second representative embodiment of the disclosure is provided. The second representative embodiment is a heated food storage container. The container includes a housing with upper and lower walls, right and left walls, and a rear wall, the housing defines an internal volume accessible through an open front portion. A heater and a fan are disposed within the housing and are configured to deliver a flow of heated air through a ventilation duct disposed within the housing. The ventilation duct includes an upper chamber, a rear chamber in fluid communication with the upper chamber, and a lower chamber in fluid communication with the rear chamber. The upper chamber is defined between an internal upper wall and the upper wall, the rear chamber is defined between an internal rear wall and the rear wall, and the lower chamber is defined between an internal lower wall and the lower wall. A plurality of parallel beams are disposed upon the lower wall and support the internal lower wall, wherein the plurality of parallel beams define a plurality of separated air flow paths through the lower chamber, wherein each of the plurality of parallel beams is shaped as a truncated triangular member with a truncated end disposed proximate an exit of the lower chamber and an opposite second end disposed proximate an entrance into the lower chamber, wherein a heights of the second end is greater than a height of the truncated end.

Advantages of the disclosed container will become more apparent to those skilled in the art from the following description of embodiments that have been shown and described by way of illustration. As will be realized, other and different embodiments are contemplated, and the disclosed details are capable of modification in various respects. Accordingly, the drawings and description are to be regarded as illustrative in nature and not as restrictive.

### BRIEF DESCRIPTION OF THE DRAWINGS

FIG. 1 is a perspective view of a food storage container.

FIG. 2 is perspective sectional view of the food storage container of FIG. 1.

FIG. 3 is a right side view of the sectional orientation of FIG. 2.

FIG. 3a is the view of FIG. 3 annotated to list other features of the view.

FIG. 4 is perspective view of the food storage container of FIG. 1 with various portions removed to depict the lower chamber and the internal volume.

FIG. 5 is a perspective view of the cowling of the food storage container of FIG. 1.

FIG. 6 is a perspective view of a beam of the food storage container of FIG. 1

FIG. 7 is a perspective view of the food storage container of FIG. 1 showing the upper chamber.

FIG. 8 is a perspective view of the container of FIG. 1 with a pan and rack disposed within the internal volume thereof.

FIG. 9 is a perspective view of the rear wall and ribs usable with the container of FIG. 1.

### DETAILED DESCRIPTION OF THE DRAWINGS AND THE PRESENTLY PREFERRED EMBODIMENTS

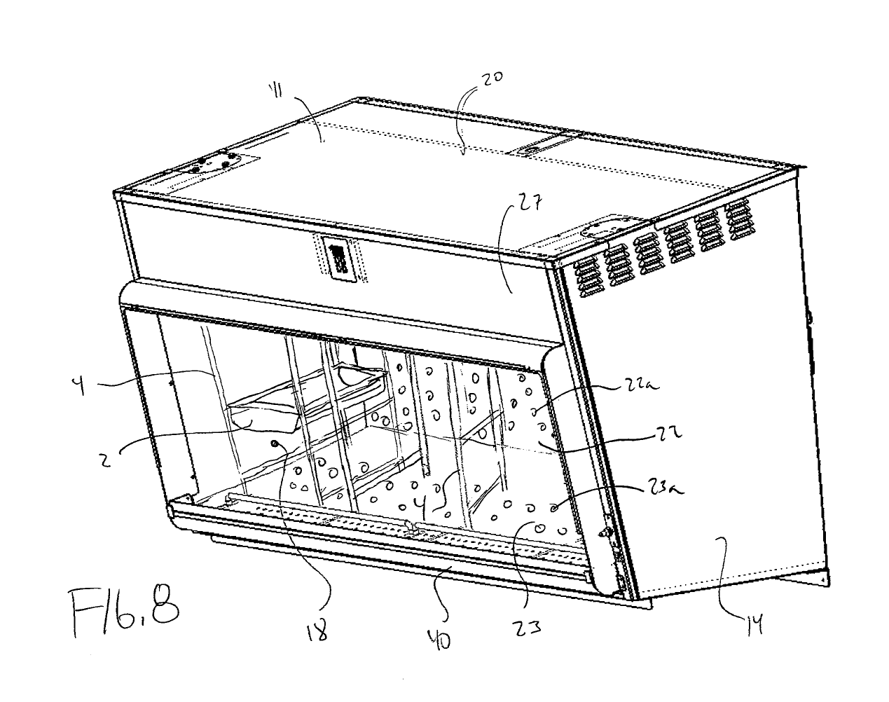

Turning now to the figures, a heated food storage container, or cabinet 10 is provided. The container 10 is configured to receive and support multiple food storage trays or sheets within an internal volume 18 therein. In some embodiments, the container 10 may be capable of storing two conventional restaurant pans 2 therein, each disposed upon a separate vertically separated rack 4, as shown in FIG. 8. The container 10 may alternatively receive and store multiple smaller pans within the internal volume such as two half pans per rack, or three one-third sized pans on each rack. In some embodiments the container 10 may be configured to sit upon a counter or other surface within a commercial kitchen or restaurant, while in other embodiments the container 10 may be configured to be able to be conveniently moved around the kitchen or facility with a plurality of castors or the like. The container 10 may be of a size to be conveniently accessed when sitting upon a counter, or may be of a larger size to rest (or move) upon the floor, similar to a larger banquet food holding cabinet. While a container 10 configured to receive multiple trays is depicted in the figures, one of ordinary skill in the art will appreciate after review of the subject specification and figures that other sizes and geometries of containers may be provided that include the general concept disclosed herein.

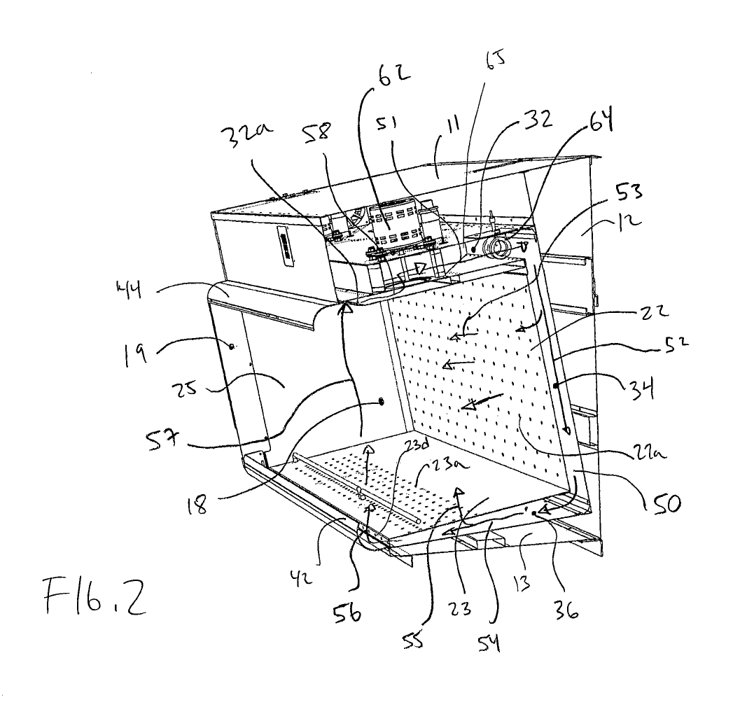

As best shown in FIGS. 2, 3, 3a, 4, and 7, the container 10 provides a flow of heated air within the internal volume 18 to maintain the temperature of the food products disposed within the pans, as well as a curtain of heated air that flows through a front opening 19 into the internal volume 18 of the container 10. The air curtain 57 establishes a barrier between the heated internal volume 18 and the environment. The flow of heated air that establishes the air curtain 57 across the front opening 19 as well as the flow of heated air 53, 55 that flows through the internal volume 18 of the container 10 is created by one or more fans 62 and one or more heating elements 64 (either electric or gas) that may be disposed within a partially enclosed mechanical compartment of the container 10, for example in an upper compartment 51. Alternatively, the fans 62 and the heating elements 64 may be disposed in other locations within the container 10, i.e. within the ventilation duct 50, to limit the possibility of personal injury due to unintended contact with the fans 62 and/or the heating elements 64.

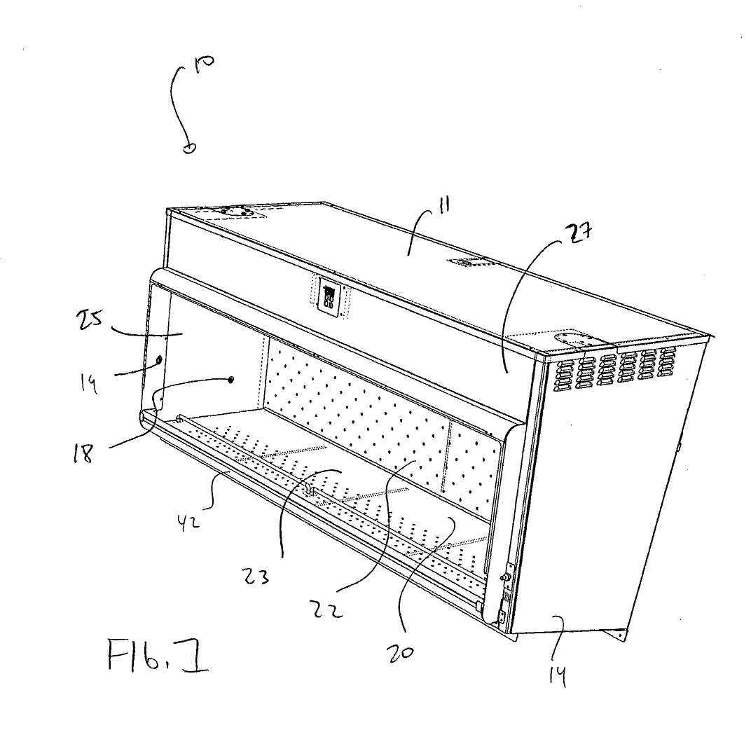

With reference to FIG. 1, the housing 20 is defined within the container 10. The housing includes opposite upper and lower walls 11, 13, opposite right and left walls 14, 15, and a rear wall 12, opposite an open end 19 to allow access to the internal volume 18. The housing 20 is disposed within the container 10 to define the internal volume 18 of the container 10 and is sized to closely receive one or more racks and food pans or the like therein.

The internal volume 18 is defined from an upper inner wall 21, a rear inner wall 22, a lower inner wall 23, a right inner wall 24, and a left inner wall 25. Each of the respective inner upper wall 21, inner rear wall 22, and the inner lower wall 23 are inwardly offset from the respective upper wall 11, rear wall 12, lower wall 13, such that an upper chamber 32 is defined between the upper wall 11 and inner upper wall 21, a rear chamber 34 is defined between the rear wall 12, and the inner rear wall 22, and a lower chamber 36 is defined between the lower wall 13 and the inner lower wall 23 (FIG. 2). Each of the upper chamber 32, the rear chamber 34, and the lower chamber 36 are in fluid communication, such that an outlet of the upper chamber 32 (i.e. the portion through which pressurized air leaving the one or more fans 62) provides direct fluid communication for air leaving the upper chamber 32 into an upper portion of the rear chamber 34, and air leaving the lower portion of the rear chamber 34 enters back portion of the lower chamber 36. The combined flow paths of the upper chamber 32, the rear chamber 34, and the lower chamber 36 define at least a portion of the ventilation duct 50.

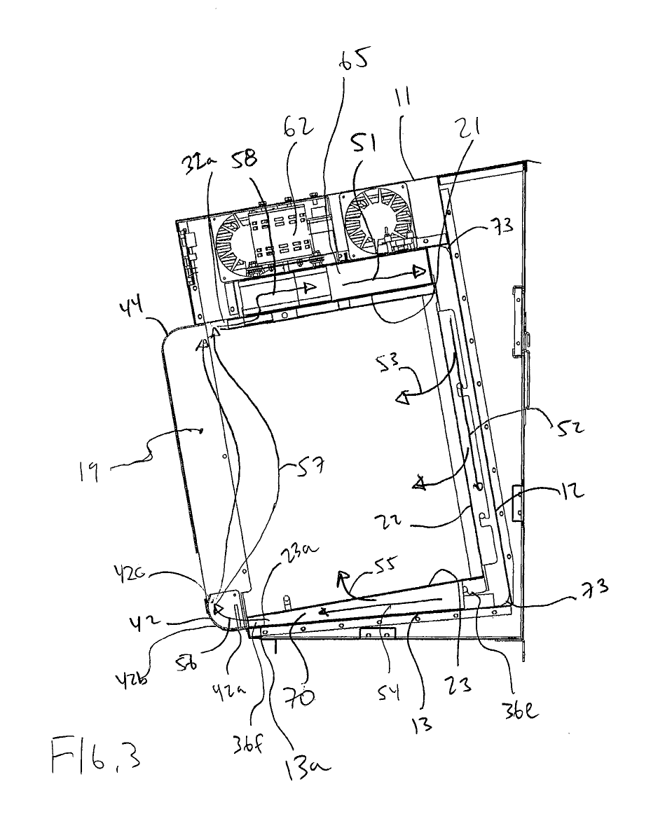

In some embodiments shown in FIGS. 2, 3, and 3a, the transition between the upper chamber 32 and the rear chamber 34 may include gradual curved member 73, such as an arcuate member or a member with several planar surfaces at large obtuse angles with respect to each other to combine to form a structure to urge the air from a relatively horizontal flow direction leaving the upper chamber 32 to a relatively vertical downward flow direction in the rear chamber 34 with minimal frictional loss to the air flow due to the gradual transition provided by the transition. Similarly, the curved member 73 between the rear chamber 34 and the lower chamber 36 may include a similar transition member to provide a gradual transition between the relatively vertically downward flow through the rear chamber 34 to the substantially horizontal flow in the lower chamber 36. For example, a relatively laminar flow has been observed in an embodiment where each curved member 73 forms four planar sections bent along their length with respect to each other, with the two outer members bent at an angle of about 163 degrees with respect to each neighboring member and both interior members bent at an angle of about 130 with respect to each other. The combined curved transmission member 73 therefore provides an overall interior angle of about 80 degrees to urge the air to gradually change the air direction between neighboring chambers.

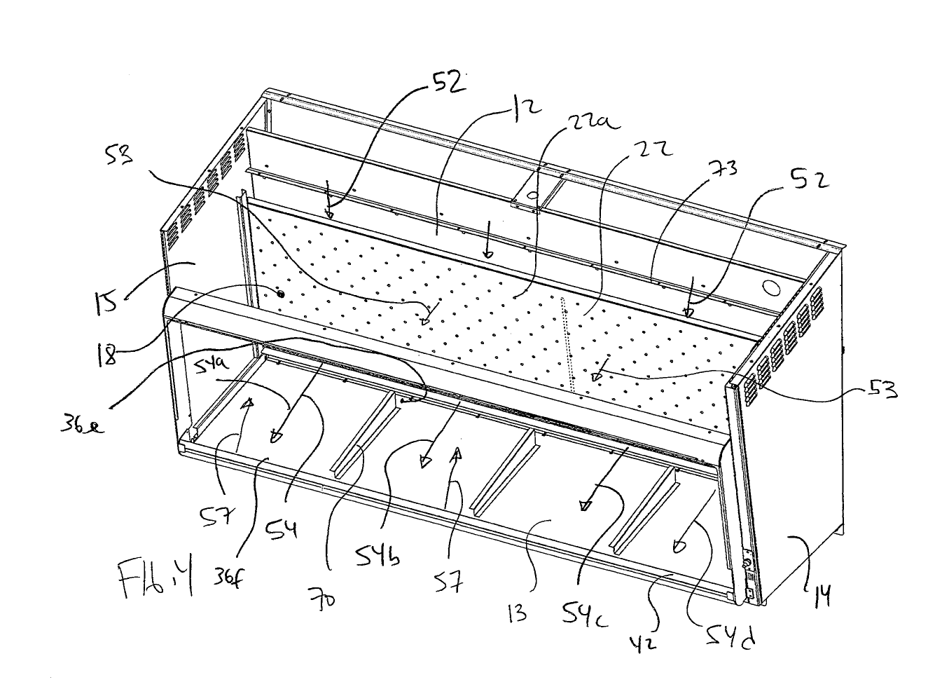

The housing 20 additionally receives an arcuate and elongate cowling 42 (FIG. 5) that is disposed upon or proximate to respective front edges 13a, 23a (FIG. 3) of the lower wall 13 and the inner lower wall 23, such that air flowing through the lower chamber 36 flows into the cowling 42. The cowling 42 is an elongate arcuate member with a substantially horizontal bottom portion 42a disposed initially to receive air leaving the lower chamber 36, a curved central portion 42b, and an upper outlet portion 42c. In some embodiments, the cowling 42 is provided with a uniform curvature along its length such that air entering the bottom portion 42a of any portion of the length of the cowling 42 flows along the cowling along the same profile, such that the flow of air leaving the outlet portion 42c is substantially uniform along the width of the housing.

In some embodiments, the cowling 42 is formed with an arc length greater than 90 degrees, but less than 180 degrees such air leaving the cowling 42 flows with a horizontal vector component directed into the internal volume 18 of the container 10. In some embodiments, the arc length of the cowling 42 may be between about 95 and 135 degrees, and more specifically between about 110 and 120 degrees, and more specifically about 115 degrees. Because of the arc length of the cowling 42, the flow of air leaving the cowling immediately leaving the cowling 42 is directed at an acute angle α with respect to the bottom wall 13 of the housing, and at a second, smaller, acute angle Δ between the angle of the outlet portion 42c of the cowling 42 and the inner lower wall 23. In some embodiments, the air leaves the cowling 42 in a range of about 50 and about 80 degrees with respect to the lower wall 13, inclusive of each individual angle within this range, in other embodiments, the air leaves the cowling 42 within a range of about 60-70 degrees, and in some embodiments the air leaves the cowling 42 at about 65 degrees or at about 60 degrees with respect to the lower wall 13.

As discussed elsewhere herein, the opening 32a into the upper chamber 32, leading directly to the suction of the one or more fans 62 is normally disposed proximate to the open front portion 19 and just within the internal volume 18. The opening 32a normally extends along the entire width of the housing 20 and provides suction along the entire length thereof to urge or assist the air leaving the cowling 42 to flow upwardly past the open front 19 of the internal volume 18 to establish the air screen 57 for the internal volume 18. The opening is normally disposed such that a line R between the outlet portion 42c of the cowling 42 and the opening 51 defines an acute angle β with respect to the lower wall 13 of the housing, wherein the acute angle β is larger than the angle α between the outlet portion 42c of the cowling and the lower wall 13.

A schematic representation of the air flow path through the housing 20 and ventilation duct 50 is depicted in FIGS. 3 and 3a. The schematic air flow path 57 that establishes the air curtain the open front portion 19 of the internal volume 18 shows that while the air initially leaves the cowling 42 in a direction generally in line with the angle α with respect to the bottom wall 13, the air curtain 57 changes direction after leaving the cowling 42 to a more vertical direction to flow through the inlet 32a to the upper chamber 32. This flow path has been experimentally determined to minimize the amount of air defining the air curtain from leaving the housing through the open front portion 19, while still maximizing the accessibility of the inner volume 18 by the user. In some embodiments shown in FIG. 2, a shield 44 may hang from the structure defining the upper front edge of the front opening 19. The shield 44 may be arcuate (as shown in FIG. 2), or alternatively the shield may be a flat plate. In some embodiments, the shield may be disposed at an outward acute angle with respect to the open front portion, at least in embodiments where the open front portion is substantially vertical. In embodiments where the open front portion 19 is disposed at an oblique angle with respect to the surface upon which the container rests, or another horizontal surface (as shown in FIG. 3), the shield 44 may be disposed at a substantially perpendicular angle with respect to the surface upon which the container rests, or at another suitable angle. The shield 44 has been determined to minimize the leakage of air from the air screen 57 (discussed in detail below), therefore increasing the thermal efficiency of the container 10. In some embodiments, the shield 44 may be movable or hingedly attached to the upper front edge that defines the front opening 19 to allow for greater access into the internal volume 18 than if the shield 44 were rigidly mounted to the container 10.

The upper chamber 32 is disposed generally in the upper portion of the housing and above the internal volume 18 of the housing 20. The upper chamber 32 includes one or more fans 62 that take suction through an opening 32a positioned within the inner volume proximate to an just behind the front opening 19. The opening 32a is normally a rectangular opening in the inner upper wall 21 or may be defined between a forward edge of the inner upper wall 21 and the front upper wall of the housing 27. The opening 32a normally extends along the entire length of the inner volume, such that an air screen 57 (i.e. the path of air flowing upwardly from the upper outlet portion 42c of the cowling 42 to the opening 32a) extends over the entire cross-section of the front opening 19.

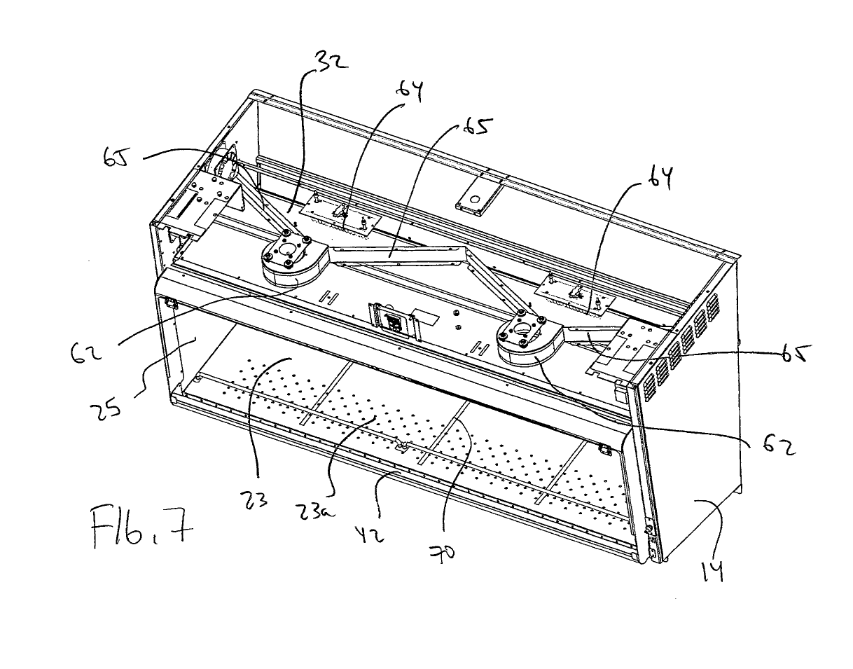

In some embodiments and as shown in FIG. 7, the upper chamber includes two or more fans 62 that are horizontally offset within the upper chamber 32 to provide a larger air flow rate through the ventilation duct 50 than would be possible with a single fan 62. Similarly, two or more fans 62 allows for a more a more uniform flow of air along the width of the upper chamber and therefore a more uniform flow of air (including uniform flow rate and a uniform temperature profile of air) flowing through the ventilation duct 50. The upper chamber 32 may include air baffles 65 to direct air leaving the fan(s) 62 past the heating units 64 and toward the rear chamber 62. The two combined baffles 65 for each fan may have gradually expanding geometries (such as at about a 130 degree angle with respect to each other) that may have an outlet end that is either the same size as the length of a heating unit 64 disposed in conjunction with the fan 62 and baffle 65 such that substantially the entire volume of air flowing through the upper chamber 32 is directed past the heating element 64 to continuously add heat to all of the air flowing through the ventilation duct 50.

In other embodiments, the baffle 65 may be configured with an outlet width that is larger than the length of the heating element 64 such that only a percentage of the air flowing through the upper chamber 32 (and therefore the air flowing through a single pass of the ventilation duct 50) flows past the heating element 64. This arrangement may be favorable when it is calculated that only a portion of the volume of air flowing through the ventilation system need be heated to maintain a relatively constant temperature within the internal volume 18 for each flow cycle based upon the size of the housing 20, nominal heat loss from the opening 18, through the walls, due to relatively colder food being placed within the internal volume, etc. The heating element 64 may be a conventional coiled heater, a heat strip, a radiator system, a gas burner, or another known heat input device.

The rear chamber 34 is fluidly connected to an exit of the upper chamber 32 (i.e. downstream with respect to the normal air flow through the ventilation duct 50) and is oriented substantially vertically, or at a small angle from vertical. The rear chamber 34 may allow for two air flow paths, a first flow path 52 directed from the upper chamber 32 to the lower chamber 36, and a second flow path 53 directing a portion of the air entering the rear chamber 34 to flow through a plurality of holes 22a disposed upon the inner rear wall 22 and into the internal volume 18. As can be understood by those of skill in the art that review and contemplate this specification, the percentage of air entering the rear chamber 34 that ultimately flows through the plurality of holes 22a and into the internal volume 18 may be a function of many factors, such as hole size, positioning, number of holes, inlet pressure, outlet pressure from the lower chamber 36, etc.

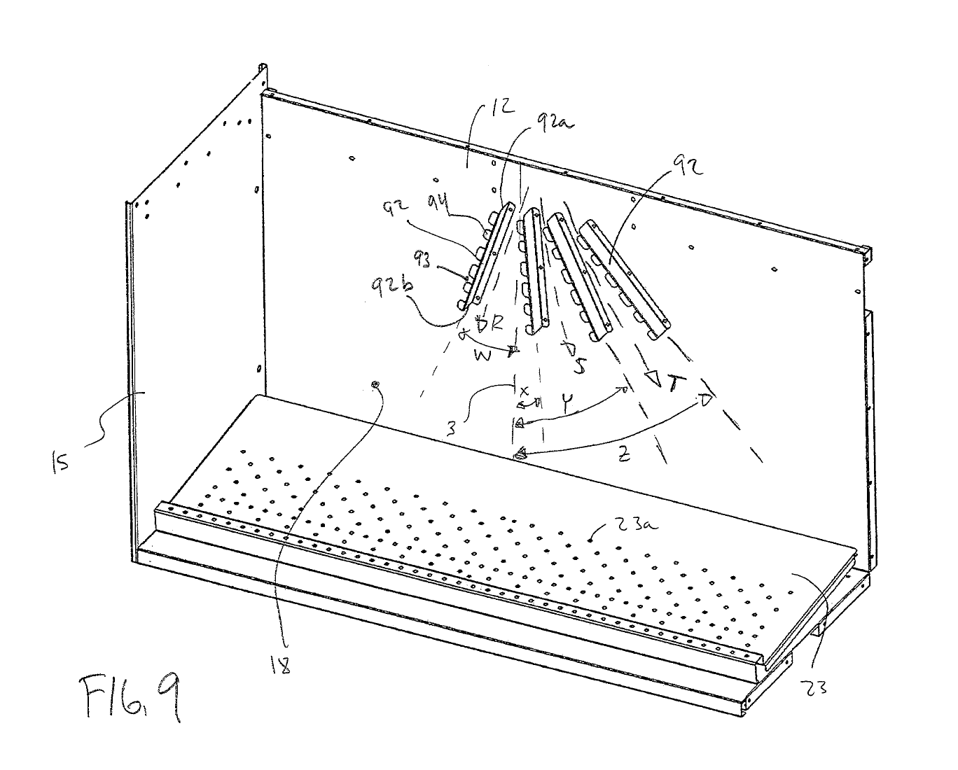

In some embodiments depicted in FIG. 9, the inner rear wall 22 and the rear wall 12 may be supported in an offset manner (establishing the rear chamber 34) with two or more ribs 92, which function to align the inner rear wall 22 and the rear 12 with respect to each other, and also form a plurality of air channels R, S, T that direct air received from the upper chamber 32 through the rear chamber 34. In embodiments where the container 10 is sized such that only a single fan 62 need be provided to establish a sufficient mass flow rate of air to establish a suitable air curtain 57, two or more of the plurality of ribs 92 may be disposed at relative angles with respect to each other such that the width of one or more of the air channels R, S, T enlarges from the combined distal ends 92a (i.e. the narrowest portion of each air channel) of the ribs 92 toward the combined proximal ends 92b of the ribs 92 (i.e. the widest portion of each air channel). This increasing width of the air channels along their length has been observed to assist in producing substantially constant air mass flow rates and a substantially small air temperature gradient along the width of the air curtain 57. In some embodiments, the plurality of ribs 92 each include a plurality of notched pads 94 that provide the surface for attachment to the inner rear wall 22. The notched pads 94 are configured to provide sufficient surface area for attachment, yet provide voids (shown schematically as 93) between the pads 94 that align with the holes 22a disposed upon the inner rear wall 22 to prevent blockage thereof by the plurality of ribs 92.

In some embodiments and with some desired sizes and geometries of the container 10, it has been observed that a substantially constant air mass flow rate and a substantially small air temperature gradient along the width of the air curtain 57 has been established where each of the plurality of ribs 92 are disposed at differing acute angles (W, X, Y, Z) with respect to a line 3 parallel to the left inner wall 25. This substantially constant flow rate and uniform temperature profile has been observed in situations where constraints in the design and placement of the fan 62 prevent the output of the fan 62 from bisecting the centerline of the container 10, and/or the direction of air leaving the fan 62 is not directed along the centerline of the container 10. By way of example, it has been found that the substantially uniform air flow profile along the air curtain 57 was established when a first rib 92 was disposed at about 19 degrees with respect to the line and on a first side of the line 3, while the remaining three ribs 92 were disposed at about 4, 25, and 42 degrees, respectively, with respect to an opposite side of the line 3.

One of ordinary skill in the art, upon review and consideration of this specification, will contemplate that in situations where the output of the fan 62 bisects the centerline of the container 10 and/or the air flow from the fan 62 extends along the centerline of the container 10, the ribs 92 may be best placed at similar angles with respect to the line and on opposite sides of the line 3, with angles selected such that the increasing width of the air channels R, S, T is approximately the same as the embodiment discussed above. One of ordinary skill in the art will understand upon review and contemplation of this specification that the specific angles and orientation of the plurality of ribs 92 to achieve a substantially uniform air flow distribution and a substantially uniform temperature distribution across the air curtain may be achieved with optimized rib angles that can be determined with performance testing and optimization, but that the concept of providing a plurality of ribs 92 at differing acute angles with respect to a line 3 parallel to the left side wall 18 (or another wall or reference point that may be appropriate to establish a line along the rear chamber) to achieve this substantially uniform air flow and temperature profile is important in establishing the substantially uniform flow and temperature distribution across the air curtain 57. As can be understood, the differing acute angles (W, X, Y, Z) of the ribs may be both numerically different angles as well as falling on opposite sides of the line 3, or in other embodiments, pairs of ribs 92 on opposite sides of the line 3 may have the same magnitude of angle and be disposed upon opposite sides of the line 3.

The lower chamber 36 is defined between the inner lower wall 23 and the lower wall 23 and provides fluid communication between the rear chamber 34 and the cowling 42. The lower chamber 36 may have two air flow paths therethrough, a first path 54 receiving air from an outlet of the rear chamber 34 and directing the air to the cowling 42, and a second path 55 directing a portion of the air entering the lower chamber 36 into the internal volume 18 through a plurality of holes 23a disposed upon the inner lower wall 23. Each of the flow paths 53 and 55 allowing air to leave the ventilation duct 50 and enter the internal volume 18 are provided to establish some convective heat transfer within the internal volume 18 to maintain the temperature of the food product disposed within the internal volume 18 at a desired temperature. The percentage of air flowing from the lower chamber 36 and into the internal volume 18 is a function of the variables similar to those discussed above with respect to the percentage of air 53 that flows directly into the internal volume 18 from the rear chamber 34.

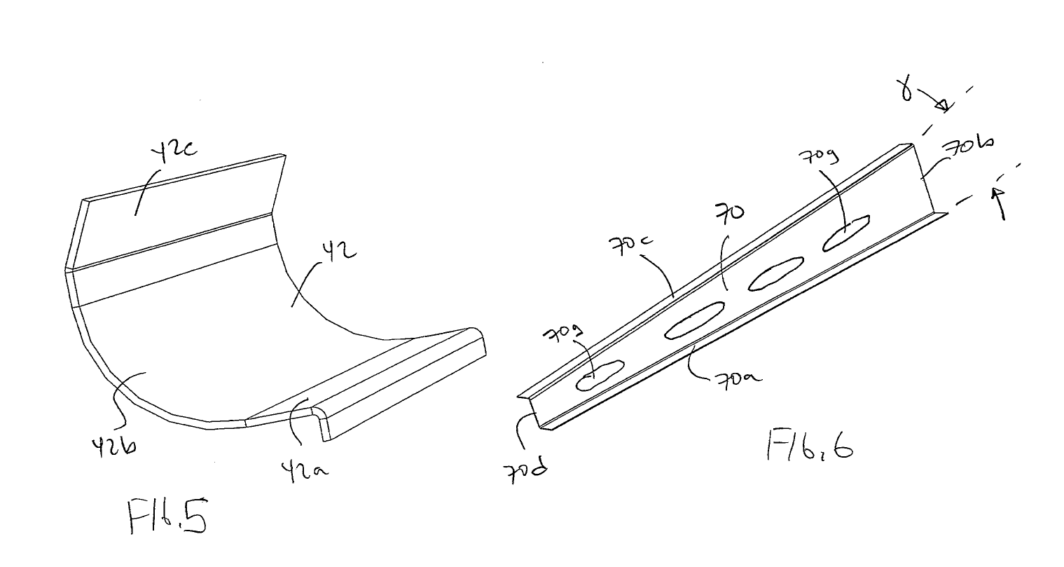

The inner lower wall 23 and the lower wall 13 are maintained in a separated orientation by a plurality of beams 70 that are disposed in parallel upon the lower wall 13 and are each fixed to a bottom surface of the inner lower wall 23. The plurality of beams 70 (FIG. 6) may each be shaped like a truncated triangle, with a base 70a that is fixed to the lower wall 13 and forms the first leg of the triangle, a rear edge 70b that forms the second leg of the triangle, and a top edge 70c between the base and the rear edge. In embodiments, where the beam 70 is a truncated right triangle, the top edge 70c is the hypotenuse. In some embodiments the base further includes a truncated front edge 70d. In some embodiments, the top edge 70c and the base 70a may be aligned with an angle γ therebetween, wherein the angle γ may be within the range of 5 to 30 degrees inclusive of all angles therein, or within the range of about 5 to 15 degrees, or within the range of about 10-20 degrees, or in some embodiments about 5 degrees, or other suitable ranges that can be optimized with knowledge of the subject specification. In other embodiments, the beam 70 may be rectangular when the downward orientation of the inner lower wall 23 is not desired.

In some embodiments, the housing 20 may be configured such that the inner upper wall 21 is disposed substantially in parallel with the inner lower wall 23, and such that the inner rear wall 22 is substantially perpendicular with the inner lower and upper walls 23, 21 such that the internal volume 18 is substantially cubical.

Each beam 70 may be formed from any cross section that is configured to be mounted to both the bottom surface of the inner lower wall 23 (along the top edge 70c of the beam 70) and the inner wall 13 (along the base 70a) such that the beam 70 is configured to carry the weight of the inner wall 23 and fix the inner lower wall 23 to define the interior volume 18. In some embodiments as shown in FIG. 6, the beam 70 may have a “Z” shaped cross section, with the two opposite horizontal surfaces of the “Z” fixed to the inner lower wall 23 and the lower wall 13, respectively. In other embodiments, the beam 70 may be formed like a conventional I-beam, or in other cross-sections to provide suitable mechanical support.

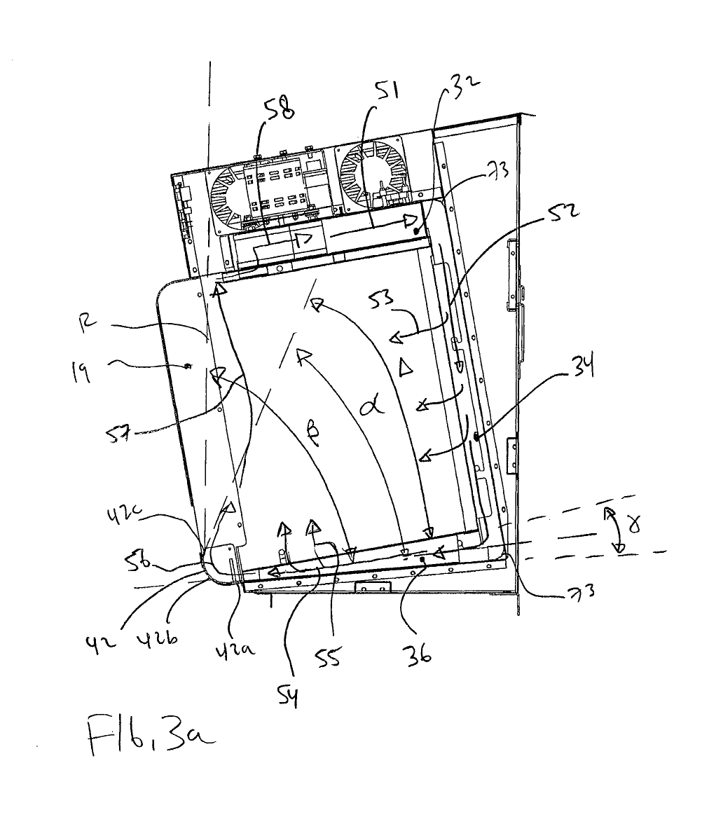

As best shown in FIG. 4, the plurality of beams 70 may be disposed between the inner lower wall 23 and the lower wall 13 to establish a plurality of parallel separated paths 36a, 36b, 36c, etc. through the lower chamber 36. In some embodiments like those shown in FIG. 4, the plurality of beams 70 may define one more path than the number of beams 70, with the paths either all being of the same width, or with differing widths. It has been experimentally determined that a substantially consistent heat profile along the opening 19 may be established when the beams are not uniformly distributed within the lower chamber 36. For example, a substantially uniform heat and flow profile has been observed in an embodiment with three parallel beams 70 disposed within the lower chamber 36, with the beams 70 positioned consecutively at 24.44% of the total width, 50.01% of the total width, and 75.11% of the total width of the inner lower wall 23, respectively.

As shown in FIGS. 3 and 4, in some embodiments, the plurality of beams 70 may each be shorter than the depth of the lower chamber 36 and the plurality of beams 70 are disposed such that the entrance into the lower chamber 36 from the rear chamber is undivided and the exit from the lower chamber 36 toward the cowling 42 is additionally undivided along the width of the lower chamber 36. The existence of the common entrance 36e and a common exit 36f from the lower chamber 36 is believed to enhance horizontal mixing of air along the width of the housing as the air makes continuous cycles, which assists with the formation of a substantially uniform temperature and air flow profile along the width of the opening 19 at steady state.

Substantially uniform flow paths have been observed in embodiments where the common entrance 36e and the common exit 36f are each a length that accounts for about 7 percent of the total length of the inner lower wall 23. For example, in an embodiment where the inner lower wall 23 is about 16 inches deep, the plurality of beams 70 are each about 13.75 inches long and are centered forward to back upon the inner lower wall 23, leaving a common entrance and common exit 36e, 36f of about 1.15 inches.

In some embodiments, one or all of the plurality of beams 70 may include one or more side apertures 70g (as shown in FIG. 6) to provide some air mixing between adjacent paths 36a, 36b, etc. within the lower chamber 36. The side apertures 70g may be disposed upon one or more of the beams 70 as experimentally determined with knowledge of the underlying specification to yield a uniform flow (both flow rate and temperature profile) across the air curtain 19. The side apertures 70g may be rectangular, arcuate (such as circular or elliptical) or as other suitable shapes, sizes, and locations. In some embodiments and as shown in FIG. 2, the inner lower wall 23 may include a perpendicular section 23d partially blocking the outlet of the common exit 36f of the lower chamber 36. the perpendicular section 23d may include a plurality of holes that provide a metered flow of air therethrough and provide for mixing within the lower chamber 36 due to the head loss provided by the perpendicular section 23d, which results in a more uniform in a more uniform temperature and flow profile across the air curtain 57.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

1. A heated food storage container, comprising:
a housing with upper and lower walls, right and left walls, and a rear wall and defining an internal volume accessible through an open front portion;
a heater and a fan disposed within the housing and configured to deliver a flow of heated air through a ventilation duct defined within the housing;
the ventilation duct comprising an upper chamber, a rear chamber in fluid communication with the upper chamber, a lower chamber in fluid communication with the rear chamber, and a cowling disposed upon a front portion of the lower chamber and configured to direct air flowing through the lower chamber in parallel with the lower wall to a second direction through the open front portion and toward an intake of the upper chamber, wherein the cowling is configured to initially urge the air leaving the cowling at a first acute angle with respect to the lower chamber.

2. The container of claim 1, wherein the first acute angle is between about 50 and about 80 degrees.

3. The container of claim 1, wherein the first acute angle is about 65 degrees.

4. The container of claim 1, wherein a suction opening is defined in the upper chamber and is configured to receive the flow of air exiting the cowling and flowing through the open front portion.

5. The container of claim 4, wherein the suction opening is disposed such that a line between the suction opening and the exit of the cowling is disposed at a second acute angle with respect to the lower chamber, wherein the second acute angle is greater than the first acute angle.

6. The container of claim 4, wherein the suction opening is configured to urge entry of air flowing past the cowling into the suction opening during operation of the fan disposed in conjunction with the ventilation duct.

7. The container of claim 1, wherein the cowling has an arc length of greater than 90 degrees and less than 180 degrees.

8. The container of claim 7, wherein the cowling has an arc length of about 110 degrees.

9. The container of claim 1, wherein the internal volume is defined from an internal upper wall, an internal rear wall, an internal lower wall, and the right and left walls, wherein the internal upper wall is offset from the upper wall to define the upper chamber, the internal rear wall is offset from the rear wall to define the rear chamber, and the internal lower wall is offset from the lower wall to define the lower chamber, wherein the internal lower wall is disposed at a third acute angle with respect to the lower wall.

10. The container of claim 9, further comprising an internal right left wall and an internal left wall, each offset inwardly from the right and left walls, respectively, and the internal right and internal left walls defining the internal volume.

11. The container of claim 9, further comprising a plurality of beams disposed in parallel within the lower chamber and configured to support the internal lower wall, wherein the plurality of beams are configured to separate the air flowing through the lower duct into multiple discrete flow paths.

12. The container of claim 11, wherein the plurality of beams each have a truncated triangular profile along their length, and wherein a forward truncated portion of each beam is disposed proximate to the cowling, and a rear leg portion of each beam is disposed proximate a transition between the rear chamber and the lower chamber.

13. The container of claim 1, wherein the rear chamber comprises an inner rear wall this rigidly offset from the rear wall by a plurality of ribs that establish a plurality of air flow paths through the rear chamber, wherein two or more of the ribs extend through the rear chamber at differing acute angles with respect to a line parallel to the left wall of the housing.

14. The container of claim 13, wherein at least four of the ribs extend through the rear chamber each at differing acute angles with respect to the line parallel to the left wall of the housing.

15. The container of claim 13, wherein a top end of each rib is aligned at a uniform distance from a top edge of the rear wall.

16. A heated food storage container, comprising:
a housing with upper and lower walls, right and left walls, and a rear wall, the housing defining an internal volume accessible through an open front portion;
a heater and a fan disposed within the housing and configured to deliver a flow of heated air through a ventilation duct disposed within the housing;
the ventilation duct comprising an upper chamber, a rear chamber in fluid communication with the upper chamber, and a lower chamber in fluid communication with the rear chamber, the upper chamber defined between an internal upper wall and the upper wall, the rear chamber defined between an internal rear wall and the rear wall, and the lower chamber defined between an internal lower wall and the lower wall,
further comprising a plurality of parallel beams disposed upon the lower wall and supporting the internal lower wall, wherein the plurality of parallel beams define a plurality of separated air flow paths through the lower chamber, wherein each of the plurality of parallel beams are shaped as truncated triangular members with a truncated end disposed proximate an exit of the lower chamber and an opposite second end disposed proximate an entrance into the lower chamber, wherein a height of the second end is greater than a height of the truncated end.

17. The container of claim 16, wherein the plurality of parallel beams comprises four beams.

18. The container of claim 16, further comprising an arcuate cowling disposed upon the housing and in fluid communication with an exit of the lower chamber and configured to receive and redirect air flowing past the plurality of parallel beams.

19. The container of claim 18, wherein the cowling has an arc-length greater than 90 degrees such that a first line disposed through a flow path of air flow leaving the cowling makes a first acute angle with a second line disposed through the combined plurality of separated flow paths through the lower chamber.

20. The container of claim 19, wherein a suction inlet of the upper chamber is disposed proximate the open front portion within the internal volume, wherein a third line between an exit of the cowling and the suction inlet forms a second acute angle with respect to the second line, wherein the second acute angle is larger than the first acute angle.

21. The container of claim 16, wherein each of the internal wall and the lower wall form acute angles with respect to a surface upon which the housing rests, wherein an acute angle between the internal lower wall and the surface is larger than a second acute angle between the lower wall and the surface.
